(19) United States
(12) Patent Application Publication
(10) Pub. No.: US 2024/0428074 A1
(43) Pub. Date: Dec. 26, 2024

(54) OPTIMIZING METHOD OF SEMI-SUPERVISED LEARNING AND COMPUTING APPARATUS

(71) Applicant: Wistron Corporation, New Taipei City (TW)

(72) Inventors: Jiun-In Guo, Hsinchu (TW); Wei-Ting Hung, Hsinchu (TW)

(73) Assignee: Wistron Corporation, New Taipei City (TW)

(21) Appl. No.: 18/446,480

(22) Filed: Aug. 9, 2023

(30) Foreign Application Priority Data
Jun. 26, 2023 (TW) 112123706

(51) Int. Cl. G06N 3/082; G06N 3/0895

(52) U.S. Cl. CPC G06N 3/082; G06N 3/0895

(57) ABSTRACT

An optimizing method of semi-supervised learning and a computing apparatus are provided. In the method, a first predicted result of a labeled data set and a second predicted result of an unlabeled data set are respectively determined through a machine learning model. A pseudo-label threshold is determined according to a first confidence score of the first predicted result of a first sample of the labeled data set. The machine learning model is updated according to a compared result of the second predicted result of a second sample of the unlabeled data set and the pseudo-label threshold.

### CROSS-REFERENCE TO RELATED APPLICATION

This application claims the priority benefit of Taiwan application serial no. 112123706 filed on Jun. 26, 2023. The entirety of the above-mentioned patent application is hereby incorporated by reference herein and made a part of this specification.

### BACKGROUND

### Technical Field

The disclosure relates to a machine learning technique, and in particular relates to an optimizing method of semi-supervised learning and computing apparatus.

### Description of Related Art

Conventional semi-supervised learning technique rely on a fixed and high threshold to generate effective pseudo-labels. In practical applications, the amount of data sets is often limited. In addition, using a high threshold will waste a large amount of unlabeled data, which not only leads to a longer initial training time, but may also inhibit the performance of the final model.

Conventional semi-supervised learning technique uses the same threshold for all unlabeled data. However, there may be differences in difficulty among multiple categories in a learning task. Different strategies should be adopted for categories of different degrees of difficulty. Using the same threshold will result in fewer pseudo-label data for the more difficult categories, indirectly causing a data imbalance problem, and further preventing effective learning in these categories.

In conventional machine learning techniques, the accuracy of the model increases linearly with the continuous addition of training data. Assuming that the amount of learnable data of the model is defined as the capacity of the model, after the amount of training data has accumulated to a certain amount, the growth of the model accuracy will gradually saturate. Even with the collection of a large amount of data, there is no further improvement in model accuracy.

In addition, conventional semi-supervised learning techniques are easily sensitive to hyperparameters, and fine-tuning parameters such as pseudo-label thresholds, data set characteristics, and data set size is required, which consumes a lot of computing resources. Even poor selection of hyperparameters may easily affect the final effect of model accuracy.

### SUMMARY

An optimizing method of semi-supervised learning and a computing apparatus, which may dynamically provide appropriate thresholds for different categories and appropriately adjust the capacity of a model, are provided.

The optimizing method of semi-supervised learning of the embodiment of the disclosure is applicable to a labeled data set and an unlabeled data set. One or more first samples in the labeled data set have been labeled as one of multiple categories, and one or more second samples in the unlabeled data set have not been labeled as one of the categories. The optimizing method includes the following operation (but not limited to the following operation). A first predicted result of the labeled data set and a second predicted result of the unlabeled data set are respectively determined through a machine learning model. A pseudo-label threshold is determined according to a first confidence score of the first predicted result of the at least one first sample of the labeled data set. The machine learning model is updated according to a compared result of a second confidence score of the second predicted result of the at least one second sample of the unlabeled data set and the pseudo-label threshold.

The computing apparatus of the embodiment of the disclosure is applicable to a labeled data set and an unlabeled data set. One or more first samples in the labeled data set have been labeled as one of multiple categories, and one or more second samples in the unlabeled data set have not been labeled as one of the categories. The computing apparatus includes (but not limited to) a storage device and a processor. The storage device stores program code. The processor is coupled to the storage device. The processor loads the program code to execute the following operation. A first predicted result of the labeled data set and a second predicted result of the unlabeled data set are respectively determined through a machine learning model. A pseudo-label threshold is determined according to a first confidence score of the first predicted result of the at least one first sample of the labeled data set. The machine learning model is updated according to a compared result of a second confidence score of the second predicted result of the at least one second sample of the unlabeled data set and the pseudo-label threshold.

Based on the above, according to the optimizing method of semi-supervised learning and the computing apparatus of the embodiments of the disclosure, the confidence score obtained from predicting labeled samples may be used to determine the threshold for judging pseudo-label. In this way, unlabeled data may be used more efficiently, the initial training time of the model may be reduced, and the recognition accuracy may be improved.

In order to make the above-mentioned features and advantages of the disclosure comprehensible, embodiments accompanied with drawings are described in detail below.

### BRIEF DESCRIPTION OF THE DRAWINGS

FIG. 1 is an element block diagram of a computing apparatus according to an embodiment of the disclosure.

FIG. 2 is a flowchart of an optimizing method of semi-supervised learning according to an embodiment of the disclosure.

FIG. 3 is a flowchart of a determining method of a pseudo-label threshold according to an embodiment of the disclosure.

FIG. 4A to FIG. 4D are schematic diagrams of application scenarios according to an embodiment of the disclosure.

FIG. 5 is a flowchart of the overall system according to an embodiment of the disclosure.

### DETAILED DESCRIPTION OF DISCLOSED EMBODIMENTS

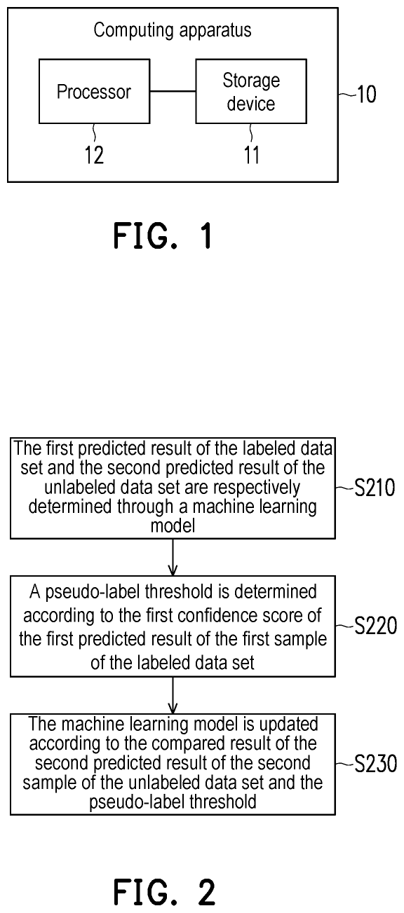

FIG. 1 is an element block diagram of a computing apparatus 10 according to an embodiment of the disclosure. Referring to FIG. 1, the computing apparatus 10 includes (but not limited to) a storage device 11 and a processor 12. The computing apparatus 10 may be one or more desktop computers, laptops, smart phones, tablets, wearable devices, servers, or other electronic devices.

The storage device 11 may be any type of fixed or movable random access memory (RAM), read only memory (ROM), flash memory, conventional hard disk drive (HDD), solid-state drive (SSD) or similar components. In one embodiment, the storage device 11 is configured to store program codes, software modules, configurations, data or files (e.g., data sets, model parameters, or pseudo-label thresholds), which are described in detail in subsequent embodiments.

The processor 12 is coupled to the storage device 11. The processor 12 may be a central processing unit (CPU), a graphics processing unit (GPU), or other programmable general-purpose or special-purpose microprocessors, a digital signal processor (DSP), a programmable controller, a field programmable gate array (FPGA), an application-specific integrated circuit (ASIC), a neural network accelerator, or other similar elements, or combinations of elements thereof. In one embodiment, the processor 12 is used to execute all or some of the operations of the computing apparatus 10, and may load and execute various program codes, software modules, files, and data stored in the storage device 11.

Hereinafter, the method according to the embodiment of the disclosure is described in conjunction with various apparatuses, components, and modules in the computer apparatus 10. Each process of the method may be adjusted according to the implementation, and is not limited to thereto.

FIG. 2 is a flowchart of an optimizing method of semi-supervised learning according to an embodiment of the disclosure. The processor 12 respectively determines the first predicted result of the labeled data set and the second predicted result of the unlabeled data set through the machine learning model (step S210). Specifically, one or more first samples in the labeled data set are labeled as one of the categories. That is to say, the labeled data set includes one or more first samples, and each first sample may be labeled through a classifier or a user operation so that each first sample has a corresponding category. According to different design requirements, the first/second sample may be video or sound. In addition, the category is, for example, the type of an object, the name of a person, or identification information. On the other hand, one or more second samples in the unlabeled data set have not been labeled as one of the categories. That is to say, the unlabeled data set includes one or more second samples, and each second sample has not been labeled through a classifier or a user operation, so that each second sample has no corresponding category.

A machine learning model refers to a model based on a machine learning algorithm (e.g., convolutional neural network (CNN), long short-term memory (LSTM), generative adversarial network (GAN), ResNet, VGG or MobileNet-v2). Machine learning algorithms may analyze the relationship between training samples (e.g., data sets) and corresponding labels (e.g., a certain category) or real results to obtain regularities from them, so as to predict unknown data through regularities. The machine learning model may be configured to infer the data to be evaluated (e.g., the first sample and/or the second sample) to generate a predicted result. The predicted result is one or more categories and their confidence scores. The confidence score reflects how confident the machine learning model is in the predicted category and/or how accurate the prediction is. If the confidence score of a certain category is higher, it indicates a higher confidence in the accuracy of the prediction for this category. If the confidence score of a certain category is lower, it indicates a lower confidence in the accuracy of the prediction for this category.

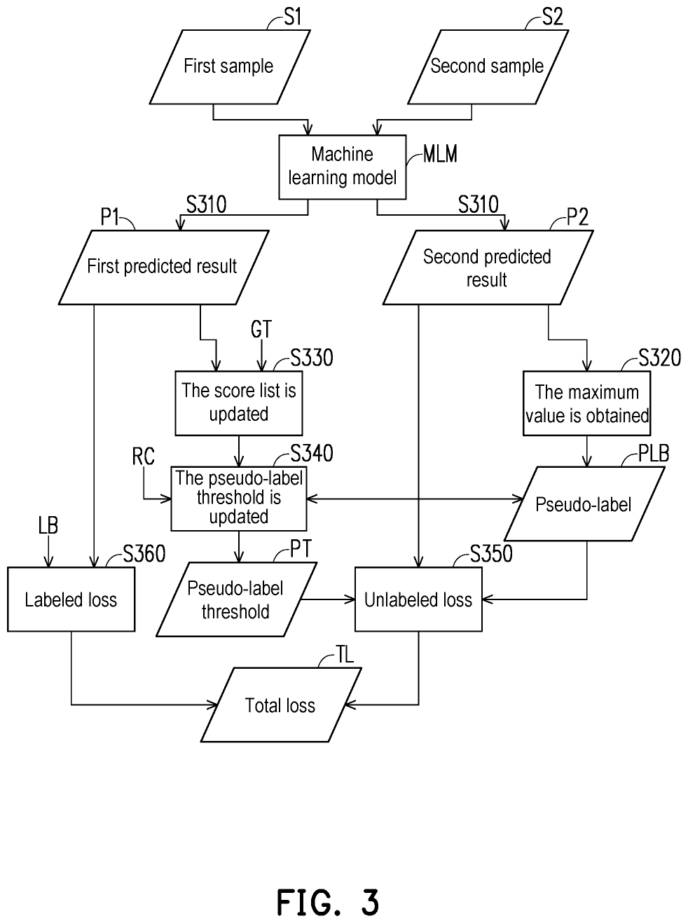

FIG. 3 is a flowchart of a determining method of a pseudo-label threshold according to an embodiment of the disclosure. Referring to FIG. 3, the first predicted result P1 is the category and its (first) confidence score obtained from the prediction of the first sample S1 by the machine learning model MLM (step S310). The second predicted result P2 is the category and its (second) confidence score obtained from the prediction of the second sample S2 by the machine learning model MLM (step S310). That is, each predicted category of each first sample S1/second sample S2 corresponds to its confidence score.

It should be noted that this machine learning model may be configured for image recognition/classification, object detection, semantic analysis, or other inferences, and the embodiments of the disclosure do not limit its use. In an application scenario, the machine learning model used for initial training is an untrained initial model. In some application scenarios, the machine learning model used for initial training or subsequent training is a trained pre-training model, and the trained pre-training model may meet the preset accuracy standard.

Referring to FIG. 2, the processor 12 determines the pseudo-label threshold according to the first confidence score of the first predicted result of one or more first samples in the labeled data set (step S220). Specifically, in order to avoid artificial adjustment of hyperparameters, the threshold required for filtering pseudo-labels (hereinafter referred to as the pseudo-label threshold) may be dynamically adjusted according to the real-time learning status of the machine learning model. Generally speaking, for each (first/second) sample, the category corresponding to the highest score among the (first/second) confidence scores in the (first/second) predicted result may be selected as the label of this sample. The label for the second sample may be referred to as a pseudo-label. This pseudo-label still needs to be compared with a pseudo-label threshold. In response to the pseudo-label not being less than the pseudo-label threshold, the processor 12 may regard the pseudo-label as valid and use the pseudo-label for subsequent training or other application requirements. On the other hand, in response to the pseudo-label being less than the pseudo-label threshold, the processor 12 may regard the pseudo-label as invalid and prohibit the use of the pseudo-label for subsequent training or other application requirements (e.g., directly ignore or delete the pseudo-label).

Since the real result of the first sample is known (i.e., it has been labeled as one of the categories), the learning status of the machine learning model may be known from the difference between the first predicted result and the real result. If there is no difference between the first predicted result and the real result or the difference is smaller, the learning state of the machine learning model is better (which may represent higher prediction accuracy). If the difference between the first predicted result and the real result is larger, the learning state of the machine learning model is poor (which may represent lower prediction accuracy).

In one embodiment, the processor 12 may select one of the first confidence scores of the first predicted result of the one or more first samples as the pseudo-label threshold. That is to say, the pseudo-label threshold is the first confidence score of a certain category predicted by the machine learning model for a certain first sample. For example, if the first confidence scores of a certain category are 0.4, 0.5, and 0.6, the pseudo-label threshold may be 0.6.

In an embodiment, the categories include a first category. The processor 12 may select the highest score among the second confidence scores of the second predicted result of the second sample, and this highest score corresponds to the first category. Taking FIG. 3 as an example, the second confidence scores of the three categories predicted for a certain second sample are 0.8, 0.7, and 0.6 respectively. The processor 12 obtains the maximum value of 0.8 (i.e., the highest score among 0.8, 0.7, and 0.6) (step S320), and uses the first category with the maximum value as the pseudo-label PLB of the second sample.

In addition, the processor 12 may select one of the first confidence scores corresponding to the first category from the first predicted result of the first sample labeled as the first category as a pseudo-label threshold for comparison with the aforementioned first category in the second sample. For example, the first confidence scores for the first category are 0.9, 0.5, and 0.4, respectively. The processor 12 selects 0.9 (i.e., the highest of 0.9, 0.5, and 0.4) as the pseudo-label threshold. It should be noted that some categories may require more training to achieve the predetermined accuracy rate (which may be referred to as higher training difficulty). Therefore, selecting respective pseudo-label thresholds for different categories may help avoid or reduce the problem of data imbalance caused by adopting the same threshold for all categories, thereby improving the recognition accuracy of each category.

In one embodiment, the processor 12 may add the first confidence score corresponding to the first category in the first predicted result of the first sample labeled as the first category to the first score table (or referred to as the first score list). Since there may be multiple first samples in the current training that have been labeled as the first category in advance (i.e., these first samples have labels before the machine learning model obtains the first predicted result, and this label may be regarded as the real result of these first samples), so the first confidence scores corresponding to the first category of these first samples are the reference basis for selecting the pseudo-label threshold corresponding to the first category. Taking FIG. 3 as an example, the processor 12 may select the first score corresponding to the real result GT (a certain category) from the first predicted result of the first sample, add the selected first score to the first score table, and generate or update the score table accordingly (step S330). Furthermore, the processor 12 may prohibit adding other first confidence scores whose real results are not of the first category to the score table.

In one embodiment, the processor 12 may define the capacity of the first score table. This capacity represents the amount of the first confidence score allowed to be stored. For example, 3, 5, or 10 first confidence scores. In response to the amount of first confidence scores of one or more first samples added to the first score table being greater than the capacity, the processor 12 may delete some of the first confidence scores of the one or more first samples in the first score table according to the sequence of addition to the first score table. In order to reflect the latest or newer learning status of the machine learning model, the first confidence scores added to the first score table earlier may be appropriately deleted. The processor 12 may sort the confidence scores in the first score table according to the time added to the first score table or the training sequence number to generate a sequence of adding to the first score table. Then, the processor 12 may preferentially delete the first confidence scores added to the first score table earlier or delete the first confidence scores with lower training sequence numbers, and preferentially retain the first confidence scores added to the first score table later or retain the first confidence scores with higher training sequence numbers. That is, the first score table is designed in the form of first in, first out (FIFO), which only retains the newest/newer output labeled scores of the machine learning model, and discards the older first confidence scores.

In one embodiment, the processor 12 may sort the first confidence scores of the one or more first samples in the first score table according to the magnitude of the scores. For example, if the first confidence scores are 0.5, 0.4, and 0.7, sorting (i.e., descending order) the first confidence scores from largest to smallest may yield 0.7, 0.5, and 0.4.

Next, the processor 12 may select a first confidence score from the first score table according to the confidence level index (or recall value) as the pseudo-label threshold of the first category. The confidence level index is, for example, 85%, 90%, or 95%, and is not limited thereto. The processor 12 finds the first confidence score corresponding to the percentile or sorting of the confidence level index as a pseudo-label threshold in this first score table. Taking FIG. 3 as an example, if the first confidence scores in the first confidence score table of the pseudo-label PLB (e.g., the first category) are 0.5, 0.65, 0.67, 0.8 and 0.85, and the confidence level index RC is 90%, then 0.85 is updated to a (new) pseudo-label threshold (step S340).

Alternatively, the processor 12 may select the highest of the first confidence scores from the first score table of the pseudo-label PLB (e.g., the first category) as the pseudo-label threshold of the first category. For example, if the first confidence scores in the first confidence score table are 0.5, 0.4, and 0.7, then 0.7 is used to update the (new) pseudo-label threshold (step S340).

It should be noted that in other application scenarios, multiple categories may also include the second category, the third category, or other categories. For the determination of the pseudo-label thresholds of other categories and/or the update of the corresponding score table, reference may be made to the above-mentioned description for the first category, which is not repeated herein.

Referring to FIG. 2, the processor 12 updates the machine learning model according to the compared result of the second confidence score of the second predicted result of the second sample in the unlabeled data set and the pseudo-label threshold (step S230). Specifically, the pseudo-label threshold is a threshold used to confirm whether the pseudo-label is valid. Taking FIG. 3 as an example, the second predicted result P2 of a certain second sample S2 includes multiple categories and their second confidence scores, the processor 12 only selects one of these categories that has the highest second confidence score and compares the selected second confidence score (i.e., the highest score) of this category with the pseudo-label threshold PT (corresponding to this category).

In one embodiment, the processor 12 may prohibit (the compared result being) one or more second samples with the highest score in its second confidence score being less than the pseudo-label threshold, and/or their corresponding second predicted results, from being used to update the machine learning model. Specifically, the difference (loss) between the second predicted result output by the machine learning model and the pseudo-label of the second sample may be used to evaluate the learning state of the machine learning model, and may be used to update/correct the parameters of the machine learning model (e.g., weights or functions). However, if the highest score among the second confidence scores of a certain second sample corresponding to multiple categories is less than the pseudo-label threshold, the second sample may be regarded as a sample that is not helpful for training, and the difference between the second predicted result and the corresponding pseudo-label may be ignored/prohibited.

On the other hand, the processor 12 may allow (the compared result being) one or more second samples with the highest score in its second confidence score not being less than the pseudo-label threshold, and/or their corresponding second predicted results, to be used for updating the machine learning model. If the highest score among the second confidence scores of a certain second sample corresponding to multiple categories is equal to or greater than the pseudo-label threshold, the second sample may be regarded as a sample that is helpful for training, and the difference between the second predicted result and the corresponding pseudo-label may be further determined.

In one embodiment, for the second sample whose highest score in the second confidence score is not less than the corresponding pseudo-label threshold, the processor 12 may establish a loss function according to the second confidence scores corresponding to the categories in the second predicted result of the second sample and the label (i.e., a pseudo-label) corresponding to the highest score. The loss function may be cross-entropy, mean square error (MSE), root mean squared error (RMSE), or other error functions. These loss functions are based on the error between the predicted result and the pseudo-label. Taking FIG. 3 as an example, if the second confidence score of a certain pseudo-label PLB is greater than or equal to the pseudo-label threshold PT, the processor 12 may use the difference between the pseudo-label PLB whose second confidence score is greater than or equal to the pseudo-label threshold PT and the predicted result of this second sample S2 to establish a loss function, and obtain an unlabeled loss (i.e., the value obtained from the loss function) (step S350). Depending on the type of loss function, other categories and their second confidence scores may also be used to establish the loss function. Taking cross-entropy and three categories as an example, the second confidence scores and pseudo-labels of the three categories may be used for comparison to establish a cross-entropy function.

Then, the processor 12 may update the machine learning model according to the loss function. For example, the processor 12 may use the value obtained from the loss function to modify/update the machine learning model through algorithms such as gradient descent or other parameter optimizing algorithms.

In one embodiment, the processor 12 may establish another loss function according to the first confidence scores corresponding to the categories in the first predicted result of each first sample and the labeled categories. The form and function of the loss function may refer to the above description, and are not repeated herein. Taking FIG. 3 as an example, the processor 12 may use the difference between the first predicted result P1 of its first sample S1 corresponding to the first confidence scores of the categories and the real result of this first sample S1 (i.e., the labeled category LB) to establish a loss function, and obtain a label loss (i.e., the value obtained from the loss function) (step S360). In one embodiment, the processor 12 may further add the unlabeled loss and the labeled loss to obtain the total loss TL (i.e., the sum of the values obtained from the two loss functions). This total loss TL may be further used to update the machine learning model MLM.

Then, the processor 12 may update the machine learning model according to the other loss function. For example, the processor 12 may use the value obtained from the other loss function to modify/update the machine learning model through algorithms such as gradient descent or other parameter optimizing algorithms.

The following is an application scenario description. However, the values in the application scenario are illustrative only.

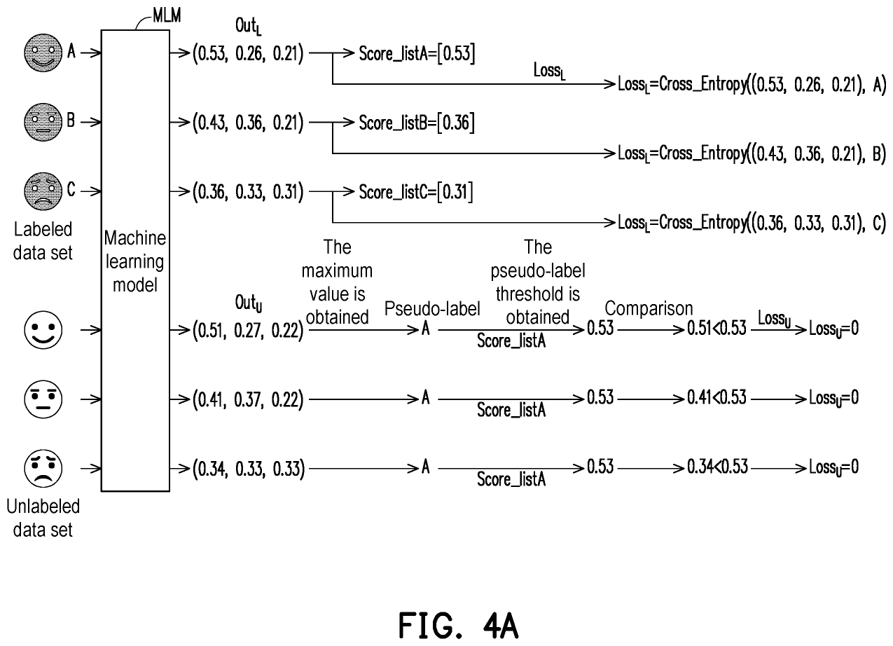

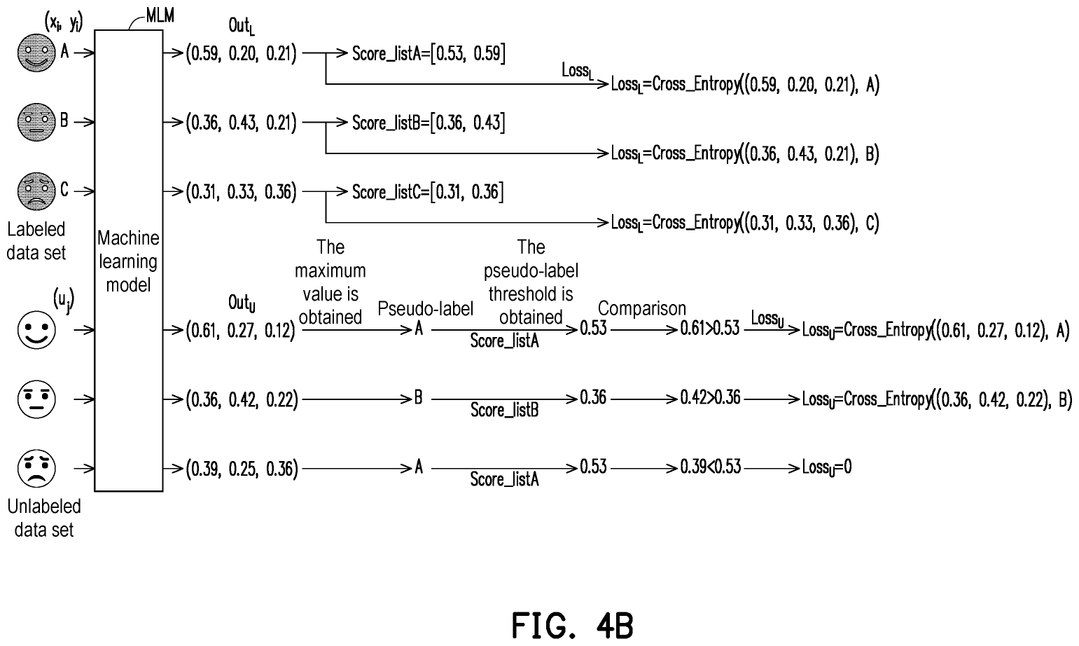

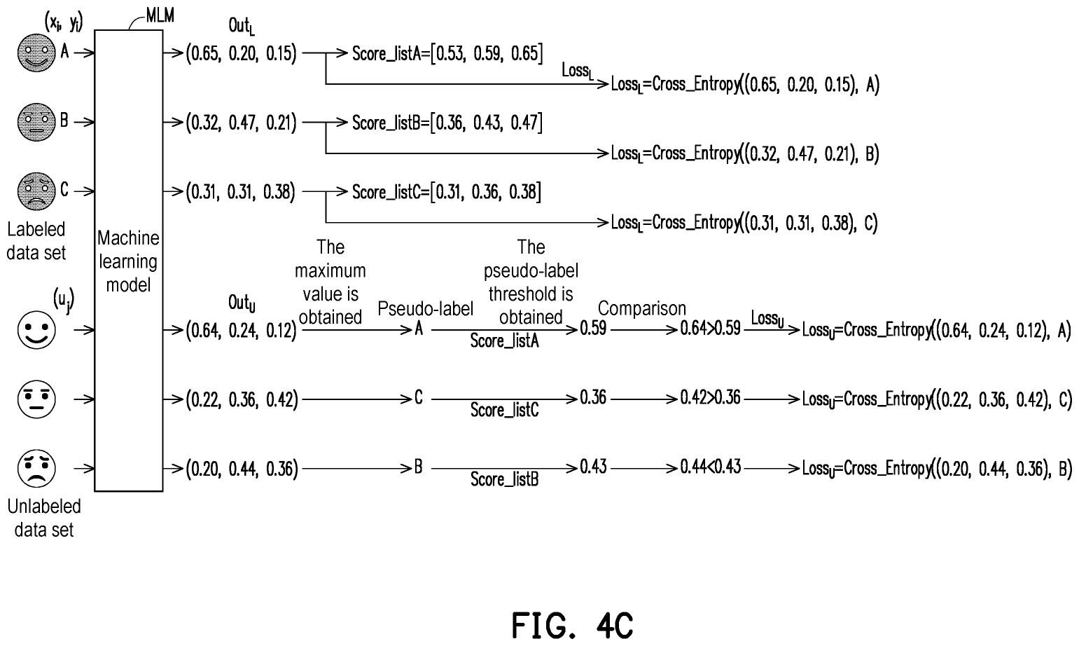

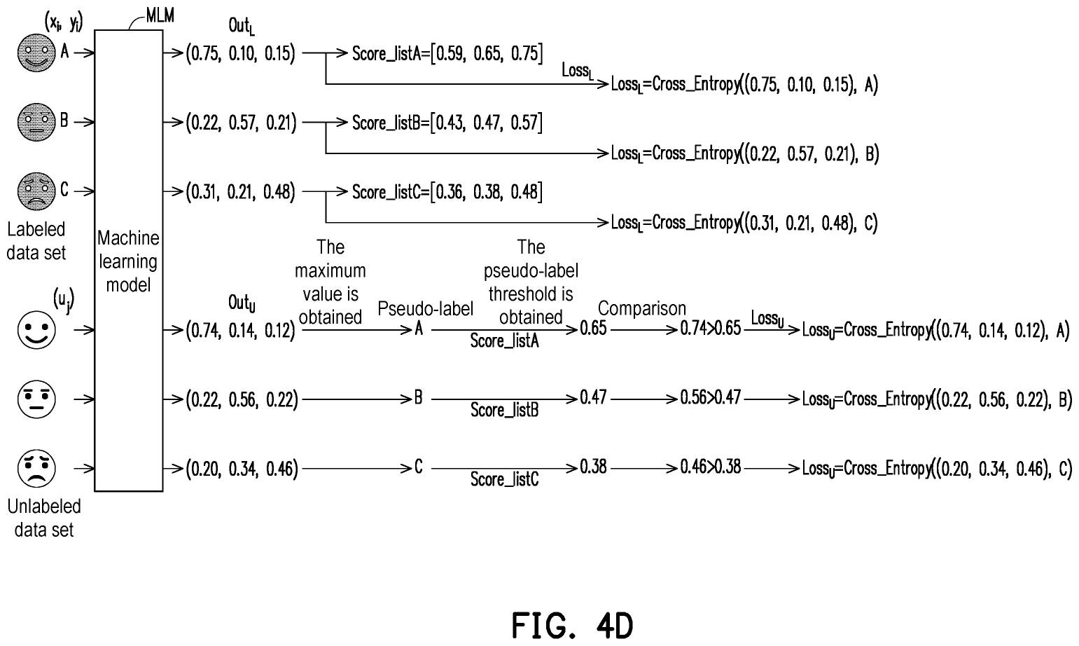

FIG. 4A to FIG. 4D are schematic diagrams of application scenarios according to an embodiment of the disclosure. Referring to FIG. 4A, in the first training, the labeled data set includes three first samples that have been respectively labeled as categories A, B, and C (real result), and the unlabeled data set includes three unlabeled second samples. The first confidence scores of the machine learning model MLM for the first predicted result OutL of the three first samples corresponding to the three categories A, B, and C are (0.53, 0.26, 0.21), (0.43, 0.36, 0.21), and (0.36, 0.33, 0.31). Therefore, the score tables Score_listA, Score_listB, and Score_listC corresponding to categories A, B, and C respectively are 0.53 corresponding to category A in (0.53, 0.26, 0.21), 0.36 corresponding to category B in (0.43, 0.36, 0.21), and 0.31 corresponding to category C in (0.36, 0.33, 0.31). In addition, since there is only one first confidence score in each score table, the first confidence scores in each score table are respectively used as pseudo-label thresholds for the corresponding categories.

On the other hand, the second confidence scores of the machine learning model MLM for the second predicted result OutU of the three second samples corresponding to the three categories A, B, and C are (0.51, 0.27, 0.22), (0.41, 0.37, 0.22), and (0.34, 0.33, 0.33). For each second sample, the category corresponding to the highest score (i.e., the maximum value) is the pseudo-label, for example, the category A corresponding to 0.51 in (0.51, 0.27, 0.22), the category A corresponding to 0.41 in (0.41, 0.37, 0.22), and the category A corresponding to 0.34 in (0.34, 0.33, 0.33). The second confidence scores of these pseudo-labels are compared to the pseudo-label threshold corresponding to category A (i.e., 0.53). Since these second confidence scores are all less than the pseudo-label threshold, the unlabeled loss LossU is 0, and these second confidence scores are not used to update the machine learning model MLM. The first confidence score and the corresponding real result may be used to determine the label loss LossL through cross-entropy.

Referring to FIG. 4B, in the second training, the labeled data set includes three first samples that have been respectively labeled as categories A, B, and C (real result), and the unlabeled data set includes three unlabeled second samples. The first confidence scores of the machine learning model MLM for the first predicted result OutL of the three first samples corresponding to the three categories A, B, and C are (0.59, 0.20, 0.21), (0.36, 0.43, 0.21), and (0.31, 0.33, 0.36). Therefore, 0.59 corresponding to category A in (0.59, 0.20, 0.21), 0.43 corresponding to category B in (0.36, 0.43, 0.21), and 0.36 corresponding to category C in (0.31, 0.33, 0.36) are respectively added to score tables Score_listA, Score_listB, and Score_listC corresponding to categories A, B, and C. In addition, assuming that the confidence level index is 90%, the pseudo-label thresholds corresponding to categories A, B, and C are 0.53, 0.36, and 0.31.

On the other hand, the second confidence scores of the machine learning model MLM for the second predicted result OutU of the three second samples corresponding to the three categories A, B, and C are (0.61, 0.27, 0.12), (0.36, 0.42, 0.22), and (0.39, 0.25, 0.36). For each second sample, the category corresponding to the highest score (i.e., the maximum value) is the pseudo-label, for example, the category A corresponding to 0.61 in (0.61, 0.27, 0.12), the category B corresponding to 0.42 in (0.36, 0.42, 0.22), and the category A corresponding to 0.39 in (0.39, 0.25, 0.36). The second confidence scores of these pseudo-labels are compared to the pseudo-label threshold corresponding to category A and B (i.e., respectively 0.53 and 0.36). Some of the second confidence score is greater than the pseudo-label threshold, so the unlabeled loss LossU may be obtained using the cross-entropy based on the pseudo-label and the second confidence score corresponding to categories A and B, and used to update the machine learning model MLM. Likewise, the first confidence score and the corresponding real result may be used to determine the label loss LossL through cross-entropy.

Referring to FIG. 4C, in the third training, the labeled data set includes three first samples that have been respectively labeled as categories A, B, and C (real result), and the unlabeled data set includes three unlabeled second samples. The first confidence scores of the machine learning model MLM for the first predicted result OutL of the three first samples corresponding to the three categories A, B, and C are (0.65, 0.20, 0.15), (0.32, 0.47, 0.21), and (0.31, 0.31, 0.38). Therefore, 0.65 corresponding to category A in (0.65, 0.20, 0.15), 0.47 corresponding to category B in (0.32, 0.47, 0.21), and 0.38 corresponding to category C in (0.31, 0.31, 0.38) are respectively added to score tables Score_listA, Score_listB, and Score_listC corresponding to categories A, B, and C. In addition, assuming that the confidence level index is 90%, the pseudo-label thresholds corresponding to categories A, B, and C are 0.59, 0.43, and 0.36.

On the other hand, the second confidence scores of the machine learning model MLM for the second predicted result OutU of the three second samples corresponding to the three categories A, B, and C are (0.64, 0.24, 0.12), (0.22, 0.36, 0.42), and (0.20, 0.44, 0.36). For each second sample, the category corresponding to the highest score (i.e., the maximum value) is the pseudo-label, for example, the category A corresponding to 0.64 in (0.64, 0.24, 0.12), the category C corresponding to 0.42 in (0.22, 0.36, 0.42), and the category B corresponding to 0.44 in (0.20, 0.44, 0.36). The second confidence scores of these pseudo-labels are compared to the pseudo-label threshold corresponding to category A, C, and B (i.e., respectively 0.59, 0.36, and 0.43). All of the second confidence score is greater than the pseudo-label threshold, so the unlabeled loss LossU may be obtained using the cross-entropy based on the pseudo-label and the second confidence score corresponding to categories A, B and C, and used to update the machine learning model MLM. Likewise, the first confidence score and the corresponding real result may be used to determine the label loss LossL through cross-entropy.

Referring to FIG. 4D, in the fourth training, the labeled data set includes three first samples that have been respectively labeled as categories A, B, and C (real result), and the unlabeled data set includes three unlabeled second samples. The first confidence scores of the machine learning model MLM for the first predicted result OutL of the three first samples corresponding to the three categories A, B, and C are (0.75, 0.10, 0.15), (0.22, 0.57, 0.21), and (0.31, 0.21, 0.48). Therefore, 0.75 corresponding to category A in (0.75, 0.10, 0.15), 0.57 corresponding to category B in (0.22, 0.57, 0.21), and 0.48 corresponding to category C in (0.31, 0.21, 0.48) are respectively added to score tables Score_listA, Score_listB, and Score_listC corresponding to categories A, B, and C. Assuming that the score tables Score_listA, Score_listB, and Score_listC have a capacity of 3, each of Score_listA, Score_listB, and Score_listC only retains the last three first confidence scores. In addition, assuming that the confidence level index is 90%, the pseudo-label thresholds corresponding to categories A, B, and C are 0.65, 0.47, and 0.38.

On the other hand, the second confidence scores of the machine learning model MLM for the second predicted result OutU of the three second samples corresponding to the three categories A, B, and C are (0.74, 0.14, 0.12), (0.22, 0.56, 0.22), and (0.20, 0.34, 0.46). For each second sample, the category corresponding to the highest score (i.e., the maximum value) is the pseudo-label, for example, the category A corresponding to 0.74 in (0.74, 0.14, 0.12), the category B corresponding to 0.56 in (0.22, 0.56, 0.22), and the category C corresponding to 0.46 in (0.20, 0.34, 0.46). The second confidence scores of these pseudo-labels are compared to the pseudo-label threshold corresponding to category A, B, and C (i.e., respectively 0.65, 0.47, and 0.38). All of the second confidence score is greater than the pseudo-label threshold, so the unlabeled loss LossU may be obtained using the cross-entropy based on the pseudo-label and the second confidence score corresponding to categories A, B and C, and used to update the machine learning model MLM. Likewise, the first confidence score and the corresponding real result may be used to determine the label loss LossL through cross-entropy.

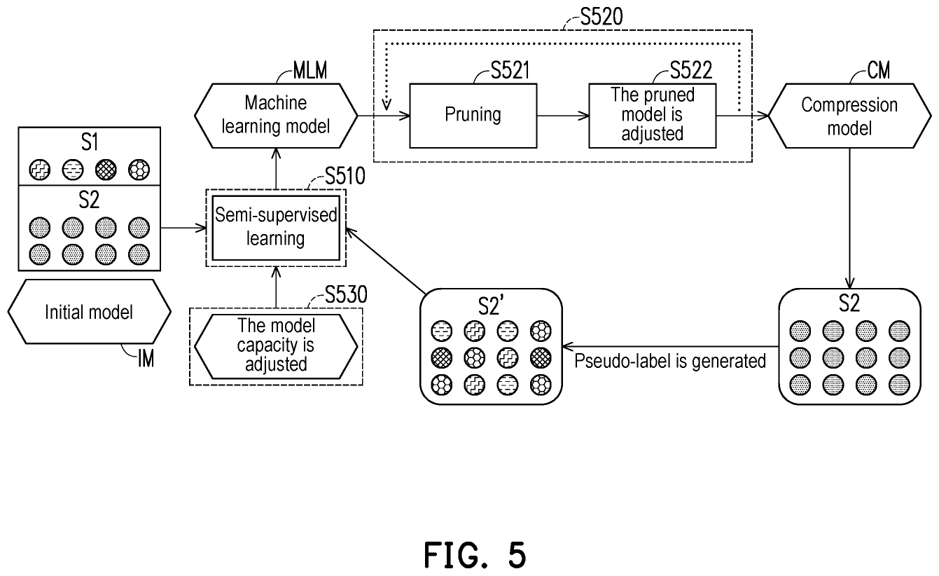

FIG. 5 is a flowchart of the overall system according to an embodiment of the disclosure. Referring to FIG. 5, in the first training, the processor 12 may perform semi-supervised learning on the first sample S1 and the second sample S2 through the initial model IM (i.e., the initial machine learning model) (step S510). The labeled first sample S1 is one of the categories, and the unlabeled second sample S2 is one of the categories. The detailed steps of the semi-supervised learning may refer to the relevant descriptions of the above-mentioned FIG. 2 to FIG. 4D, and are not repeated herein. The first predicted result of the first sample S1 and the second predicted result of the second sample S2 may be used to update the machine learning model MLM.

In one embodiment, for model compression or lightweight (step S520), the processor 12 may prune the machine learning model MLM (step S521), and remove one or more redundant neurons of the updated machine learning model MLM. The criteria for pruning is: the greater the absolute value of the weight value of a neuron, the more important the neuron is; the smaller the absolute value of the weight value of the neuron, the less important and redundant the neuron is. The pruning step is as follows: for the trained machine learning model MLM, the processor 12 may take the absolute value of the weight value of the neurons of each layer and sort the absolute value of these weight values from small to large. The processor 12 may remove neurons with smaller weight values (e.g., 50% of smaller weight values) according to the pruning ratio (e.g., it is desired to reduce the weight by 50%).

For example, the original weight values are 3.27, −1.15, 0.22, −6.17, 1.03, −4.31, 0.16, −0.29, 0.56, and their absolute values are 3.27, 1.15, 0.22, 6.17, 1.03, 4.31, 0.16, 0.29, and 0.56. These absolute values, sorted from smallest to largest, are 6.17, 4.31, 3.27, 1.15, 1.03, 0.56, 0.29, 0.22, and 0.16. It is assumed that 0.29, 0.22, and 0.16 are removed, while the remaining weight values are retained.

It should be noted that the pruning algorithm may also be channel, weight, filter, excitation, gradient, hidden layer pruning or pruning search method.

In one embodiment, the processor 12 may adjust weights corresponding to neurons other than redundant neurons in the updated machine learning model (step S522). Specifically, after each pruning, the processor 12 may retrain the pruned machine learning model MLM. For example, the processor 12 may initialize the weight values of the remaining neurons back to the parameters of the initial model IM, and then retrain the pruned machine learning model MLM to generate the compressed model CM.

Next, the processor 12 may obtain the second predicted result of the second sample S2 through the compression model CM, and use the category corresponding to the highest score in the second predicted result of each second sample S2 as a pseudo-label, so that the second sample S2 is labeled and becomes the updated second sample S2′. The updated second sample S2′ may be regarded as a labeled sample and may be further used for supervised learning.

In one embodiment, the processor 12 may increase the parameter capacity of the machine learning model MLM (step S530). The parameter capacity is the amount of parameter inputs for the machine learning model MLM. For example, the dimension of the filter (i.e., the parameters of the machine learning model MLM) of the convolutional layer is x*y*c (all are positive integers), and the c direction/dimension may be regarded as the amount of filters. The meaning of increasing the width of the model is to expand to n° C. (n is a positive integer) in the direction of c. Not only the amount of input parameters to this layer (i.e., the first or second samples that are input) may be increased, but also the amount of output feature maps generated by this layer. Therefore, the parameter capacity is increased by expanding the c direction.

In summary, the semi-supervised learning optimizing method and computing apparatus of the embodiment of the disclosure include the following features:

Dynamically adjusting the pseudo-label threshold: the pseudo-label threshold is dynamically adjusted according to the current learning state of the machine learning model. In the early stage of model learning, a lower pseudo-label threshold is used to obtain more pseudo-label data, so as to quickly train the model to a basic recognition ability. In the middle and later stages of model learning, the label threshold is adjusted to a higher value to obtain more accurate pseudo-labels, thereby further improving the model recognition ability.

Formulating the corresponding appropriate pseudo-label threshold according to the category: the pseudo-label threshold of each category is adjusted according to the current learning state of the model for each category. For more difficult categories (e.g., more learning is required to achieve the predetermined recognition ability), a lower pseudo-label threshold is used to obtain more pseudo-label data than before to strengthen the learning of this category; for simpler categories (e.g., less learning is required to achieve the predetermined recognition ability), a higher pseudo-label threshold is used to obtain more accurate pseudo-labels to further improve the recognition ability of the model for this category.

Increasing model capacity: after a machine learning model uses a certain amount of training data, the model capacity is gradually saturated, and the accuracy growth begins to slow down. Expanding the width of the model to increase its parameter capacity may mitigate the degree of model capacity saturation, and effectively utilize a large amount of data to improve model accuracy.

Model compression: in some application scenarios, increasing the model capacity by expanding the width of the model causes a large increase in model parameters, thereby affecting the speed at which the model operates in an edge device. Therefore, model pruning technique may be used to remove a large amount of redundant neurons in the model and fine-tune the remaining neurons, so that the model is only formed of important neurons, and the growth of model parameters may be slowed down.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. An optimizing method of semi-supervised learning, applicable to a labeled data set and an unlabeled data set, wherein at least one first sample in the labeled data set is labeled as one of a plurality of categories, and at least one second sample in the unlabeled data set is not labeled as one of the categories, and the optimizing method comprises:
respectively determining a first predicted result of the labeled data set and a second predicted result of the unlabeled data set through a machine learning model;
determining a pseudo-label threshold according to first confidence scores of the first predicted result of the at least one first sample of the labeled data set; and
updating the machine learning model according to a compared result of second confidence scores of the second predicted result of the at least one second sample in the unlabeled data set and the pseudo-label threshold.

2. The optimizing method of semi-supervised learning according to claim 1, wherein determining the pseudo-label threshold according to the first confidence score of the first predicted result of the at least one first sample of the labeled data set comprises:
selecting one from the first confidence scores of the first predicted result of the at least one first sample as the pseudo-label threshold.

3. The optimizing method of semi-supervised learning according to claim 2, wherein the categories comprise a first category, and determining the pseudo-label threshold according to the first confidence score of the first predicted result of the at least one first sample of the labeled data set comprises:
selecting a highest score in the second confidence scores of the second predicted result of the at least one second sample, wherein the highest score corresponds to the first category; and
selecting one of the first confidence scores corresponding to the first category from the first predicted result of the at least one first sample labeled as the first category as the pseudo-label threshold for comparing the first category in the at least one second sample.

4. The optimizing method of semi-supervised learning according to claim 3, wherein selecting one of the first confidence scores corresponding to the first category from the first predicted result of the at least one first sample labeled as the first category as the pseudo-label threshold for comparing the first category in the at least one second sample comprises:
adding the first confidence scores corresponding to the first category from the first predicted result of the at least one first sample labeled as the first category in a first score table;
sorting the first confidence scores of the at least one first sample in the first score table according to the magnitude of the first confidence scores; and
selecting a first confidence score from the first score table according to a confidence level index or selecting the highest one of the first confidence scores from the first score table as the pseudo-label threshold.

5. The optimizing method of semi-supervised learning according to claim 4, further comprising:
defining a capacity of the first score table; and
in response to an amount of first confidence scores of the at least one first sample added to the first score table being greater than the capacity, deleting some of the first confidence scores of the at least one first sample in the first score table according to a sequence of addition to the first score table.

6. The optimizing method of semi-supervised learning according to claim 1, wherein updating the machine learning model according to the compared result of the second confidence scores of the second predicted result of the at least one second sample in the unlabeled data set and the pseudo-label threshold comprises:
prohibiting the at least one second sample with a highest score in the second confidence scores being less than the pseudo-label threshold or the corresponding second predicted result from being used to update the machine learning model; and
allowing the at least one second sample with a highest score in the second confidence scores not being less than the pseudo-label threshold or the corresponding second predicted result to be used for updating the machine learning model.

7. The optimizing method of semi-supervised learning according to claim 6, wherein allowing the at least one second sample with the highest score in the second confidence scores not being less than the pseudo-label threshold or the corresponding second predicted result to be used for updating the machine learning model comprises:
establishing a loss function according to the second confidence scores corresponding to the categories in the second predicted result of the at least one second sample and a label corresponding to the highest score; and
updating the machine learning model according to the loss function.

8. The optimizing method of semi-supervised learning according to claim 7, further comprising:
establishing another loss function according to the first confidence scores corresponding to the categories in the first predicted result of each of the least one first sample and labeled category;
and updating the machine learning model according to the another loss function.

9. The optimizing method of semi-supervised learning according to claim 1, further comprising:
removing at least one redundant neuron in an updated machine learning model; and
adjusting weight corresponding to neurons other than the at least one redundant neuron in the updated machine learning model.

10. The optimizing method of semi-supervised learning according to claim 1, further comprising:
increasing a parameter capacity of the machine learning model, wherein the parameter capacity is an amount of parameter inputs for the machine learning model.

11. A computing apparatus, applicable to a labeled data set and an unlabeled data set, wherein at least one first sample in the labeled data set is labeled as one of a plurality of categories, and at least one second sample in the unlabeled data set is not labeled as one of the categories, and the computing apparatus comprises:
a storage device, storing program code; and
a processor, coupled to the storage device and loading the program code to execute:
respectively determining a first predicted result of the labeled data set and a second predicted result of the unlabeled data set through a machine learning model;
determining a pseudo-label threshold according to first confidence scores of the first predicted result of the at least one first sample of the labeled data set; and
updating the machine learning model according to a compared result of second confidence scores of the second predicted result of the at least one second sample in the unlabeled data set and the pseudo-label threshold.

12. The computing apparatus according to claim 11, wherein the processor further executes:
selecting one from the first confidence scores of the first predicted result of the at least one first sample as the pseudo-label threshold.

13. The computing apparatus according to claim 12, wherein the categories comprise a first category, and the processor further executes:
selecting a highest score in the second confidence scores of the second predicted result of the at least one second sample, wherein the highest score corresponds to the first category; and
selecting one of the first confidence scores corresponding to the first category from the first predicted result of the at least one first sample labeled as the first category as the pseudo-label threshold for comparing the first category in the at least one second sample.

14. The computing apparatus according to claim 13, wherein the processor further executes:
adding the first confidence scores corresponding to the first category from the first predicted result of the at least one first sample labeled as the first category in a first score table;
sorting the first confidence scores of the at least one first sample in the first score table according to the magnitude of the first confidence scores; and
selecting a first confidence score from the first score table according to a confidence level index or selecting the highest one of the first confidence scores from the first score table as the pseudo-label threshold.

15. The computing apparatus according to claim 14, wherein the processor further executes:
defining a capacity of the first score table; and
in response to an amount of first confidence scores of the at least one first sample added to the first score table being greater than the capacity, deleting some of the first confidence scores of the at least one first sample in the first score table according to a sequence of addition to the first score table.

16. The computing apparatus according to claim 11, wherein the processor further executes:
prohibiting the at least one second sample with a highest score in the second confidence scores being less than the pseudo-label threshold or the corresponding second predicted result from being used to update the machine learning model; and
allowing the at least one second sample with a highest score in the second confidence scores not being less than the pseudo-label threshold or the corresponding second predicted result to be used for updating the machine learning model.

17. The computing apparatus according to claim 16, wherein the processor further executes:
establishing a loss function according to the second confidence scores corresponding to the categories in the second predicted result of the at least one second sample and a category corresponding to the highest score; and
updating the machine learning model according to the loss function.

18. The computing apparatus according to claim 17, wherein the processor further executes:
establishing another loss function according to the first confidence scores corresponding to the categories in the first predicted result of each of the least one first sample and labeled category;
and updating the machine learning model according to the another loss function.

19. The computing apparatus according to claim 11, wherein the processor further executes:
removing at least one redundant neuron in an updated machine learning model; and
adjusting weight corresponding to neurons other than the at least one redundant neuron in the updated machine learning model.

20. The computing apparatus according to claim 11, wherein the processor further executes:
increasing a parameter capacity of the machine learning model, wherein the parameter capacity is an amount of parameter inputs for the machine learning model.
